(19) United States
(12) Patent Application Publication
(10) Pub. No.: US 2024/0005575 A1
(43) Pub. Date: Jan. 4, 2024

(54) SYMBOL ADDING METHOD, SYMBOL ADDING APPARATUS AND PROGRAM

(71) Applicant: NIPPON TELEGRAPH AND TELEPHONE CORPORATION, Tokyo (JP)

(72) Inventors: Ayaka SANO, Tokyo (JP); Shunichi SEKO, Tokyo (JP); Yuki KURAUCHI, Tokyo (JP)

(21) Appl. No.: 18/253,170

(22) PCT Filed: Nov. 19, 2020
(86) PCT No.: PCT/JP2020/043233

§ 371 Date: May 16, 2023

(51) Int. Cl. G06T 11/60; G06T 7/70

(52) U.S. Cl. CPC G06T 11/60; G06T 7/70; G06T 2207/20081; G06T 2207/30201; G06T 2207/10016

(57) ABSTRACT

A computer executes: a learning procedure of learning a model for estimating an addition mode of a symbol representing a state of a person in a video to the video on the basis of learning data indicating the addition mode of the symbol to the video; and an addition procedure of estimating the addition mode of the symbol to the video of a web conference using the model learned and adding the symbol to the video in the addition mode estimated, thereby increasing an amount of information that can be grasped from the video.

### TECHNICAL FIELD

The present invention relates to a symbol adding method, a symbol adding apparatus, and a program.

### BACKGROUND ART

As a method of holding a conference, not only face-to-face but also various methods such as a web conference using a PC or the like are adopted. Since a web conference can be held without actually gathering at a physical place, improvement in operation efficiency can be expected.

### CITATION LIST

### Non Patent Literature

Non Patent Literature 1: Daiki Yokoyama, Sachiko Kodama, “Emotion FX: CG Effect Automatic Generation Application That Emphasizes Facial Emotion in Moving Image in Real Time”, [online], Internet <URL:http://www.interaction-ipsj.org/proceedings/2020/data/pdf/1A-10.pdf>

### SUMMARY OF INVENTION

### Technical Problem

However, in comparison with a conversation in face-to-face, it is difficult to read the intention and state of the other party because the amount of information that can be received is small due to the low resolution of the video to be transmitted in the web conference.

Although it is possible to read an emotion of a person by detecting a state or an emotion from an action or an attitude of the person and adding information corresponding to the emotion to a video, it has been conventionally difficult to add such information in an appropriate manner.

The present invention has been made in view of the above points, and an object thereof is to increase an amount of information that can be grasped from a video.

### Solution to Problem

Therefore, in order to solve the above problem, a computer executes: a learning procedure of learning a model for estimating an addition mode of a symbol representing a state of a person in a video to the video on the basis of learning data indicating the addition mode of the symbol to the video; and an addition procedure of estimating the addition mode of the symbol to the video of a web conference using the model learned and adding the symbol to the video in the addition mode estimated.

### Advantageous Effects of Invention

It is possible to increase the amount of information that can be grasped from the video.

### BRIEF DESCRIPTION OF DRAWINGS

FIG. 1 is a diagram illustrating a hardware configuration example of a manga symbol addition device 10 according to a first embodiment.

FIG. 2 is a diagram illustrating a functional configuration example of the manga symbol addition device 10 according to the first embodiment.

FIG. 3 is a diagram illustrating a configuration example of a correct manga symbol label.

FIG. 4 is a diagram for explaining a state realized in the first embodiment.

FIG. 5 is a diagram illustrating a functional configuration example of a manga symbol addition device 10 according to a second embodiment.

FIG. 6 is a diagram illustrating a configuration example of action/manga symbol correspondence data.

FIG. 7 is a diagram for explaining an effect obtained by a third embodiment.

FIG. 8 is a diagram for explaining an effect obtained by a fourth embodiment.

### DESCRIPTION OF EMBODIMENTS

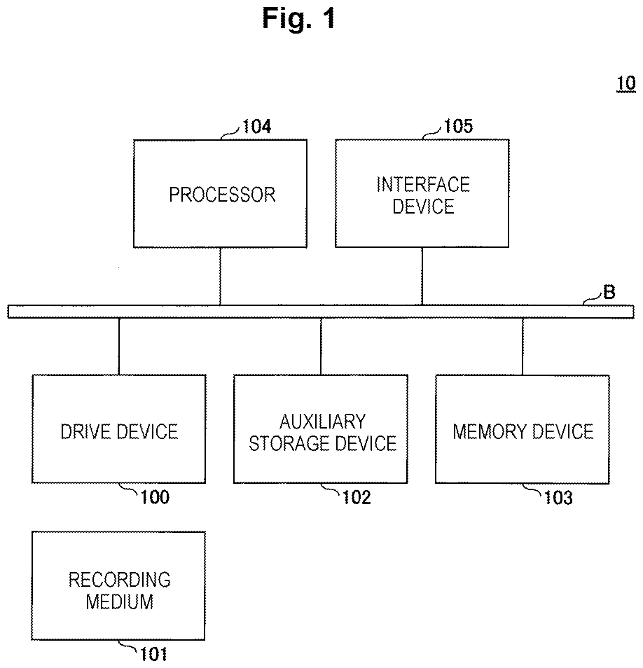

Hereinafter, embodiments of the present invention will be described with reference to the drawings. FIG. 1 is a diagram illustrating a hardware configuration example of a manga symbol addition device 10 (symbol adding apparatus) according to a first embodiment. The manga symbol addition device 10 of FIG. 1 includes a drive device 100, an auxiliary storage device 102, a memory device 103, a processor 104, an interface device 105, and the like which are connected to each other by a bus B.

A program for implementing the processing in the manga symbol addition device 10 is provided by a recording medium 101 such as a CD-ROM. When the recording medium 101 storing the program is set in the drive device 100, the program is installed from the recording medium 101 to the auxiliary storage device 102 via the drive device 100. However, the program is not necessarily installed from the recording medium 101, and may be downloaded from another computer via a network. The auxiliary storage device 102 stores the installed program and also stores necessary files, data, and the like.

When an instruction to start the program is issued, the memory device 103 reads the program from the auxiliary storage device 102 and stores the program. The processor 104 is a CPU or a graphics processing unit (GPU), or a CPU and a GPU, and executes a function related to the manga symbol addition device 10 according to the program stored in the memory device 103. The interface device 105 is used as an interface for connecting to a network.

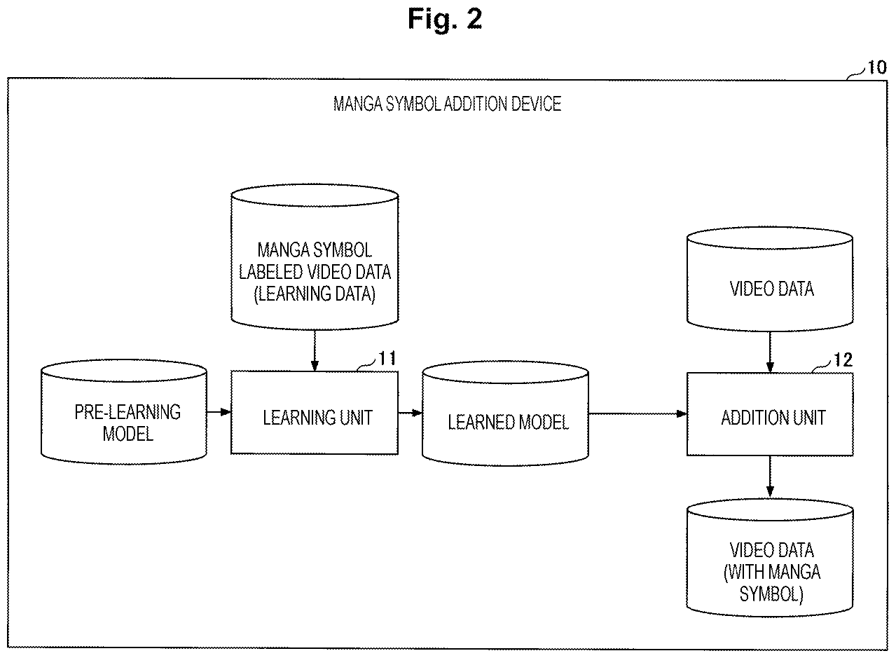

FIG. 2 is a diagram illustrating an example of a functional configuration of the manga symbol addition device 10 according to the first embodiment. In FIG. 2, the manga symbol addition device 10 includes a learning unit 11 and an addition unit 12. Each of these units is implemented by processing executed by the processor 104 by one or more programs installed in the manga symbol addition device 10.

The learning unit 11 learns a machine learning model (hereinafter, referred to as a “manga symbol addition mode estimation model”) for estimating a mode (whether or not it is necessary to add a manga symbol, and the type, position, size, and the like of the manga symbol to be superimposed when superimposition of the manga symbol is necessary) of superposition (hereinafter, simply referred to as “addition”) of a manga symbol with respect to video data using manga symbol labeled video data as learning data, and outputs the learned model. Note that the manga symbol is an example of a symbol expressing a state (expression, action, or the like) of a person.

The manga symbol labeled video data means data in which a correct manga symbol label such as a manga symbol corresponding to a state of a certain participant (hereinafter, referred to as a “user A”), an addition position of the manga symbol, and a size of the manga symbol is assigned to a time section having a characteristic state of the participant in video data (including voice) obtained by recording video and audio of already performed web conferences, for example.

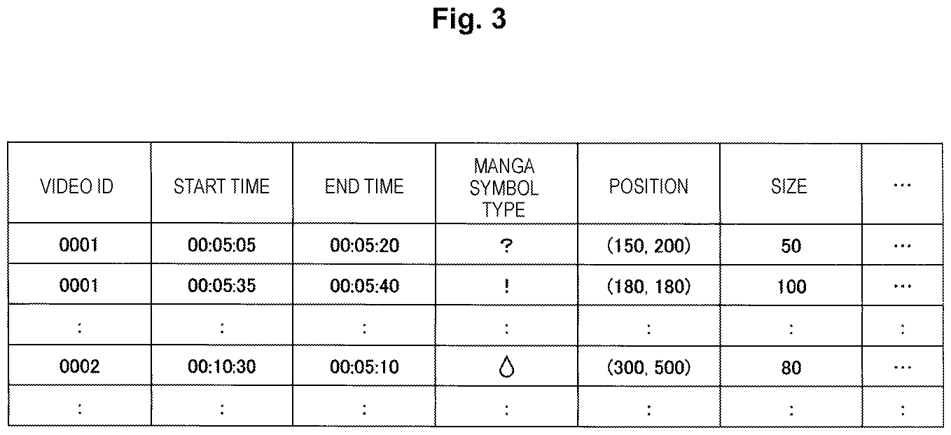

FIG. 3 is a diagram illustrating a configuration example of a correct manga symbol label. As illustrated in FIG. 3, the correct manga symbol label includes a video ID, a start time, an end time, a manga symbol type, a position (a position in a two-dimensional space in a video area), a size, and the like.

The video ID is identification information for each video data (for example, for each web conference). The start time is a start time of a time section in which any manga symbol is added to the video data related to the video ID. The end time is an end time of the time section. The manga symbol type is a type of manga symbol superimposed on the video of the time section. The position is a position (a position on the video) at which the manga symbol is added to the video of the time section. The size is the size of the manga symbol in the time section.

The learning unit 11 learns a manga symbol addition mode estimation model so as to reproduce such a correct manga symbol label, and outputs a learned model. The learned model is, for example, a machine learning model that has learned a correspondence relationship between a feature (for example, an emotion or a body motion such as nodding of the user A) of a video in each time section in a correct manga symbol label and an addition mode (manga symbol type, position, size, etc.) of the manga symbol. The feature may be automatically extracted by deep learning or the like.

For example, the addition unit 12 inputs video data of a web conference currently being held between the user A and another person (hereinafter, referred to as a “user B”), and estimates an addition mode of a manga symbol for a part or all of the time sections of the video data using the learned model. That is, the addition unit 12 estimates a manga symbol to be added to the video data with the type, position, and size as learned by the learned model. On the basis of the estimation result, the addition unit 12 adds a manga symbol to the video data and outputs the video data to which the manga symbol is added. The video data output from the addition unit 12 is transmitted to the terminal of the other party (user B) of the user A in the web conference.

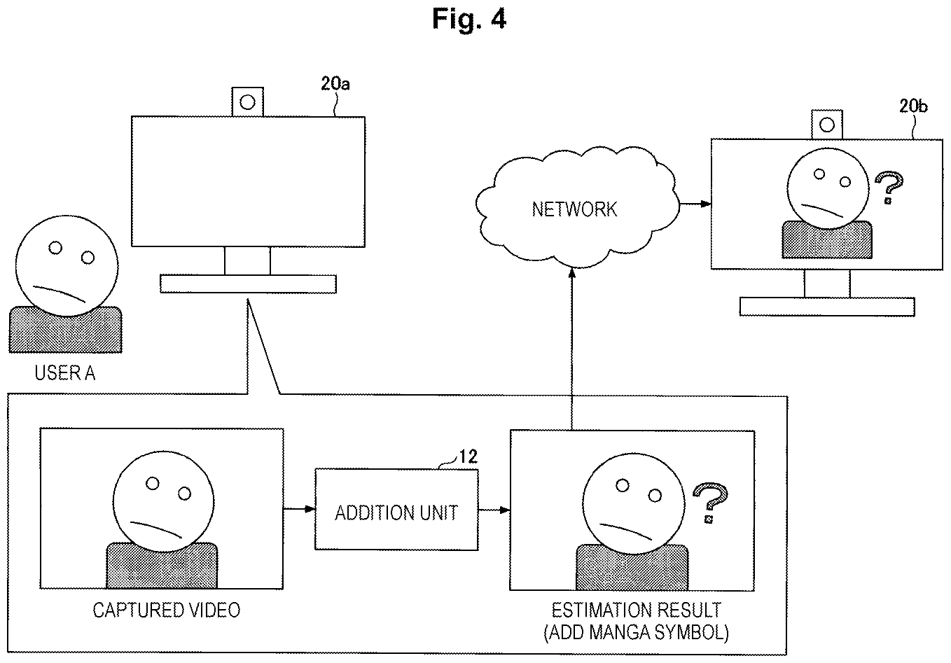

FIG. 4 is a diagram for explaining a state realized in the first embodiment. FIG. 4 illustrates an example in which video data obtained by capturing a state in which the user A tilts the head is transmitted from a terminal 20a of the user A to a terminal 20b of the user B. In this case, the addition unit 12 estimates an addition mode of a manga symbol to the video data using the learned model, and adds the manga symbol to the video data on the basis of the estimation result. In the example of FIG. 4, a relatively large “?” is added. Video data in which “?” is added is transmitted to the terminal 20b. Note that the estimation by the addition unit 12 (addition of a manga symbol) is executed at short time intervals such as 0.1 second intervals, for example. Therefore, the video data to which the manga symbol is added is transmitted to the terminal 20b of the user B substantially in real time. In addition, the manga symbol addition device 10 may be included in the terminal 20a, or may be connected to the terminal 20a via a network.

As described above, according to the first embodiment, a manga symbol can be added in a mode corresponding to video data. That is, it is possible to superimpose a manga symbol suitable for the state of the person on the video at a suitable position and size. As a result, the amount of information that can be grasped from the video can be increased.

Next, a second embodiment will be described. In the second embodiment, points different from the first embodiment will be described. The points not specifically mentioned in the second embodiment may be the same as those in the first embodiment.

In the first embodiment, it is necessary to prepare manga symbol labeled video data in advance. In addition, it is considered that the generalization performance of the learned model is improved as the number of pieces of manga symbol labeled video data increases. However, preparing a large amount of manga symbol labeled video data (correct answer data) places a heavy work load on the user. Therefore, in the second embodiment, an example in which such a work load can be reduced will be described.

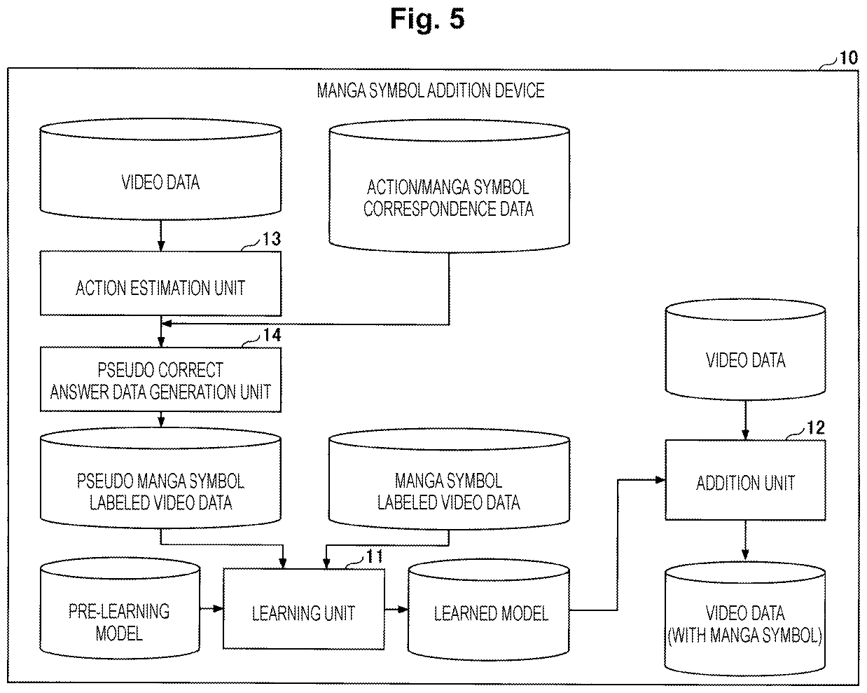

FIG. 5 is a diagram illustrating a functional configuration example of a manga symbol addition device 10 according to the second embodiment. In FIG. 5, the same or corresponding parts as those in FIG. 2 are denoted by the same reference numerals.

In FIG. 5, the manga symbol addition device 10 further includes an action estimation unit 13 and a pseudo correct answer data generation unit 14. Each of these units is implemented by processing executed by the processor 104 by one or more programs installed in the manga symbol addition device 10.

The action estimation unit 13 estimates an action of the user A in time series for video data that is video data obtained by recording a web conference and to which a correct manga symbol label is not assigned, and assigns a label (hereinafter, referred to as an “action label”) indicating the action to a time section in which the action is estimated. Note that, for example, a known technique disclosed in “https://www.ntt.com/about-us/press-releases/news/article/2015/20151007_4.html” or the like may be used to estimate the action of the person captured in the video.

The pseudo correct answer data generation unit 14 generates pseudo manga symbol labeled video data by referring to action/manga symbol correspondence data with respect to the video data to which the action label is assigned by the action estimation unit 13.

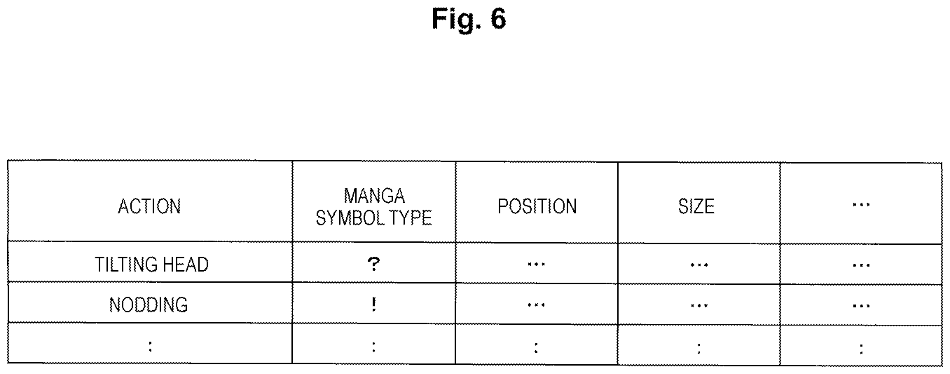

FIG. 6 is a diagram illustrating a configuration example of the action/manga symbol correspondence data. As illustrated in FIG. 6, the action/manga symbol correspondence data is data in which an addition mode of a manga symbol is recorded according to an action. The action is an action that is desired to be a target to which a manga symbol is assigned, such as “tilting the head” or “nodding”. The pseudo correct answer data generation unit 14 generates a manga symbol label indicating an addition mode corresponding to the action estimated by the action estimation unit 13, and generates video data (hereinafter, such video data is referred to as “video data with pseudo manga symbol”) to which the manga symbol label (hereinafter, the manga symbol label generated by the pseudo correct answer data generation unit 14 is referred to as a “pseudo manga symbol label”) is assigned.

The learning unit 11 learns the manga symbol addition mode estimation model by using the pseudo manga symbol labeled video data (pseudo correct answer data) as learning data in addition to the correct manga symbol labeled video data (correct answer data). Note that the learning unit 11 may learn the manga symbol addition mode estimation model using only the pseudo manga symbol labeled video data as the learning data.

As described above, according to the second embodiment, the user can automatically obtain the pseudo correct answer data by creating the action/manga symbol correspondence data. As a result, the work load for obtaining a large amount of correct answer data can be reduced.

Next, a third embodiment will be described. In the third embodiment, points different from the first or second embodiment will be described. The points not specifically mentioned in the third embodiment may be the same as those in the first or second embodiment.

In the third embodiment, a color of a manga symbol is added to an addition mode of the manga symbol. Specifically, in a case where the emotional intensity of a participant A included in the video is high (alternatively, in a case where the action is large), a color (for example, red and the like) is added to the manga symbol so that the manga symbol is emphasized.

In this case, “color” may be included in the correct manga symbol label (FIG. 3). The learning unit 11 learns a manga symbol addition mode estimation model that can also estimate the color of the manga symbol. The addition unit 12 adds a manga symbol in the color included in the estimation result of the manga symbol addition mode estimation model to the video data.

In a case where the second embodiment is combined with the third embodiment, an addition mode of a manga symbol including a color of the manga symbol may be defined for each degree of action in the action/manga symbol correspondence data. The degree of action is a degree of magnitude of action (a degree of emotional intensity). For example, in the case of “tilting the neck”, the degree of “large” means “tilting the neck greatly”.

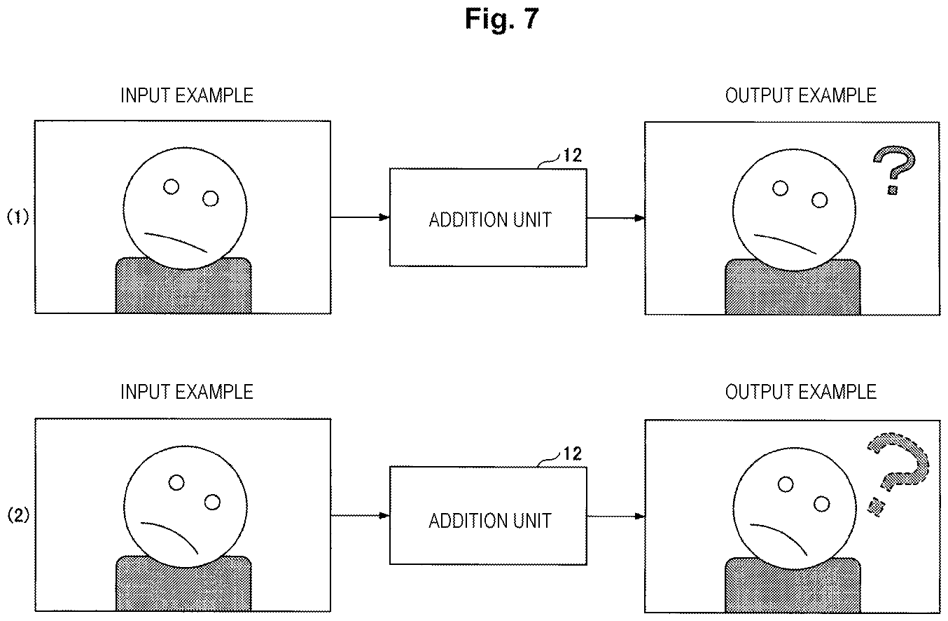

FIG. 7 is a diagram for explaining an effect obtained by the third embodiment. In FIG. 7, (1) illustrates an addition example of a manga symbol in a case where the user A tilts the neck slightly. In this case, since the emotional intensity of the user A is low, the size of the manga symbol is relatively small, and the color of the manga symbol is, for example, black.

(2) illustrates an addition example of a manga symbol in a case where the user A tilts the head greatly. In this case, since the emotional intensity of the user A is high, the size of the manga symbol is relatively large, and the manga symbol is colored (for example, red or the like). Note that, in the drawing, being surrounded by a broken line indicates being colored.

Next, a fourth embodiment will be described. In the fourth embodiment, points different from the above embodiments will be described. The points that are not specifically mentioned in the fourth embodiment may be the same as those in each of the above embodiments.

In the fourth embodiment, the “size” in the addition mode of the manga symbol dynamically changes according to the size of the face of the user A in the video (the ratio of the face area to the video area). Specifically, the larger the face of the participant A included in the video, the larger the manga symbol.

In this case, the “size” of the manga symbol in the correct manga symbol label (FIG. 3) may be set according to the size of the face of the video to which the manga symbol is added.

In addition, in a case where the second embodiment is combined with the third embodiment, the action estimation unit 13 may estimate not only the action but also the size of the face. In the action/manga symbol correspondence data, the addition mode of the manga symbol may be further defined such that the “size” of the manga symbol changes according to the size of the face.

As a result, the learning unit 11 can learn a manga symbol addition mode estimation model that changes the color of the manga symbol according to the size of the face of the user A in the video. Therefore, the addition unit 12 can change the color of the manga symbol to be superimposed on the video according to the size of the face of the user A in the video.

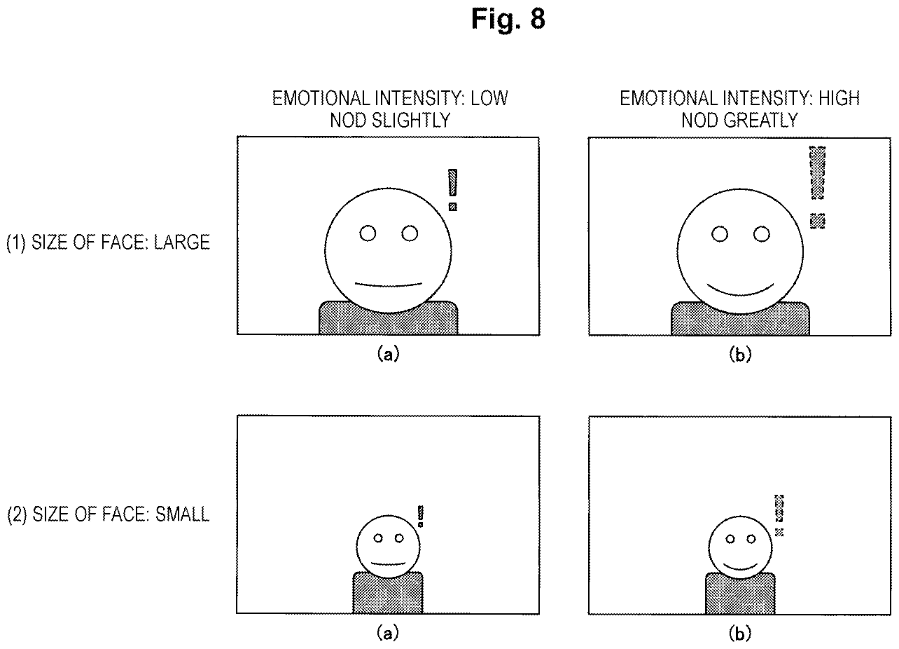

FIG. 8 is a diagram for explaining an effect obtained by the fourth embodiment. In FIG. 8, (1) illustrates an addition example of a manga symbol in a case where the face appears large. (2) illustrates an addition example of a manga symbol in a case where the face appears small. Furthermore, (a) of each of (1) and (2) illustrates a case where the emotional intensity is low, and (b) illustrates a case where the emotional intensity is high. As is clear from the comparison between (a) of (1) and (2) and (b) of (1) and (2), the size of the manga symbol can be changed according to the size of the face even if the emotional intensity is the same. Furthermore, for example, as is clear from the comparison between (a) of (1) and (b) of (2), the color of the manga symbol can be changed according to the difference in emotional intensity. Note that, in the drawing, being surrounded by a broken line indicates being colored.

Note that, in the present embodiment, the manga symbol addition device 10 is an example of a symbol addition device.

Although the embodiments of the present invention have been described in detail above, the present invention is not limited to such specific embodiments, and various modifications and changes can be made within the scope of the gist of the present invention described in the claims.

### REFERENCE SIGNS LIST

10 Manga symbol addition device
11 Learning unit
12 Addition unit
13 Action estimation unit
14 Pseudo correct answer data generation unit
100 Drive device
101 Recording medium
102 Auxiliary storage device
103 Memory device
104 Processor
105 Interface device
B Bus

1. A symbol adding method executed by a computer, the symbol adding method comprising:
learning a model for estimating an addition mode of a symbol representing a state of a person in a video to the video on a basis of learning data indicating the addition mode of the symbol to the video; and
estimating the addition mode of the symbol to the video of a web conference using the model learned and adding the symbol to the video in the addition mode estimated.

2. The symbol adding method according to claim 1, wherein the computer executes:
estimating the state of the person in the video related to the learning data; and
generating the learning data on a basis of the addition mode associated in advance with the estimated state and the video in which the state is estimated.

3. The symbol adding method according to claim 1, wherein
the addition mode includes a position and a size at which the symbol is added.

4. The symbol adding method according to claim 3, wherein
the addition mode further includes a color of the symbol.

5. The symbol adding method according to claim 3, wherein
the learning data changes the size of the symbol according to a ratio of a face of a person to an area of the video.

6. A symbol adding apparatus comprising:
a processor; and
a memory that includes instructions, which when executed, cause the processor to execute:
leaning a model for estimating an addition mode of a symbol representing a state of a person in a video to the video on a basis of learning data indicating the addition mode of the symbol to the video; and
estimating the addition mode of the symbol to the video of a web conference using the model learned and adding the symbol to the video in the addition mode estimated.

7. A non-transitory computer-readable recording medium storing a program that causes a computer to execute the symbol adding method according to claim 1.
